(19) United States
(12) Patent Application Publication
(10) Pub. No.: US 2004/0148594 A1
(43) Pub. Date: Jul. 29, 2004

(54) Acquiring call-stack information

(76) Inventor: Stephen Williams, Santa Cruz, CA (US)

Correspondence Address: HEWLETT-PACKARD COMPANY, Intellectual Property Administration, P.O. Box 272400, Fort Collins, CO, 80527-2400, US

(21) Appl. No.: 10/351,028

(22) Filed: Jan. 24, 2003

(51) Int. Cl. G06F 9/45

(52) U.S. Cl. 717/158

(57) ABSTRACT

Techniques are provided for acquiring call-stack information of a program application running on a computer system. To track function invocations, the application is instrumented so that while the application is executing, function entry and exit points are recorded in instrumentation records. A performance tool samples the application at various sample points. At each sample point, the performance tool stops the application, receives the instrumentation records, records the application's instruction pointer, and allows the application to resume execution. While the application is executing again, the performance tool, based on the function entry and exit records, constructs the call stack at the sample point. Once a call stack for a sample point has been constructed, the performance tool discards all function entry and exit records for that sample point. Alternatively, the instrumentation records, besides function entry and exit points, include time stamps at each entry and exit point. While the application is executing, the instrumentation records are generated, and the kernel of the computer system samples the application. At each sample point, the kernel time stamps the sample point and records the application's instruction pointer. Upon acquiring the time stamps and instruction pointers for a set of, e.g., eight, sample points, the kernel provides these acquired data to the performance tool. Based on the time stamps for each sample point and function entry and exit records including time stamps at each entry and exit point, the performance tool constructs the corresponding call stacks. Techniques of the invention are also applicable in situations in which the application runs on a process having multiple threads. In such situations, the relevant recorded data also includes the corresponding thread identifications, based on which the call stack for each thread is constructed. Generally, the recorded instruction pointers help identify instructions at each sample point.

### FIELD OF THE INVENTION

The present invention relates generally to program call stacks, and, more specifically, to acquiring information about such call stacks.

### BACKGROUND OF THE INVENTION

To help identify causes of application performance problems, performance tools need to be able to record an application's most frequent or hottest call stacks so that the most frequent callers of hot routines can be ascertained. At least two approaches have been used, but both are fraught with problems. In a first approach, the performance tool stops the application, unwinds and records its call stack, resumes the application, and builds up a profile of the stacks over time. Unfortunately, unwinding the call stacks in this approach is expensive, e.g., taking processor's time, requiring a lot of calculations, and can cause the application to run very slow because, during unwinding, the application cannot execute its instructions to move forward. In general, unwinding a stack refers to finding the caller of a function, the caller of the caller, etc., until all functions on the stack at a given point in time have been identified. Unwinding the stack typically begins with stopping the measured application and recording its current context, i.e., the function that is executing, the return link to the previous frame, the frame marker, register values, etc. Using the current context, the context record for the current function's caller can be reconstructed. The context record for the caller can then be used to reconstruct the context record for the caller's caller, and so on, until the entire stack has been traversed. Using this approach at small sampling intervals, the application is noticeably unable to make progress in its execution.

In a second approach, the performance tool instruments function entry and exit points so that every function entry and exit during the application execution is recorded. After data collection is complete, the accumulated data is used to reconstruct the application's call stack at various points of the application execution. However, this approach generates such a tremendous amount of data that is impractical for use with large applications.

Based on the foregoing, it is desirable that mechanisms be provided to solve the above deficiencies and related problems.

### SUMMARY OF THE INVENTION

The present invention, in various embodiments, provides techniques for sampling call-stack information of a program application running on a computer system. In one embodiment, to track function invocations, the application is instrumented so that while the application is executing, function entry and exit points are recorded in instrumentation records. A performance tool samples the application at various sample points. At each sample point, the function entry and exit records for that sample point have been generated, the performance tool stops the application, records the application's instruction pointer, and allows the application to resume execution. While the application is executing again, the performance tool, based on the function entry and exit records, constructs the call stack at the sample point. Once a call stack for the sample point has been constructed, the performance tool discards all function entry and exit records for that sample point. The recorded instruction pointers help identify instructions at each sample point.

In an alternative embodiment, the instrumentation records, besides function entry and exit points, include time stamps at each function entry and exit point. While the application is executing, the instrumentation records are generated, and the kernel of the computer system samples the application. At each sample point, the kernel time stamps the sample point and records the application's instruction pointer. From the time stamps for each sample point and the time stamps for function entry and exit points, functions that belong to a particular sample point may be ascertained. Upon acquiring the time stamps and instruction pointers for a set of, e.g., eight, sample points, the kernel provides these acquired data to the performance tool. Based on the time stamps for each sample point and function entry and exit records including time stamps at each entry and exit point, the performance tool constructs the corresponding call stacks. The recorded instruction pointers, as in the first embodiment, help identify instructions at each sample point.

Techniques of the invention are also applicable in situations in which the application runs on a process having multiple threads. In such situations, the relevant recorded data also includes the corresponding thread identifications, based on which the call stack for each thread is constructed.

### BRIEF DESCRIPTION OF THE DRAWINGS

The present invention is illustrated by way of example, and not by way of limitation, in the figures of the accompanying drawings in which like reference numerals refer to similar elements and in which:

FIG. 1 shows a system upon which embodiment of the invention may be implemented;

FIG. 2 shows an instrumentation record, in accordance with one embodiment;

FIG. 3 shows a first call stack constructed from the instrumentation record in FIG. 2, for a first exemplary sample point, in accordance with one embodiment;

FIG. 4 shows a second call stack constructed from the instrumentation record in FIG. 2, for a second exemplary sample point, in accordance with one embodiment;

FIG. 5 is a flow chart illustrating the steps in acquiring information in a call stack, in accordance with one embodiment;

FIG. 6 shows an instrumentation record having time stamps, in accordance with one embodiment;

FIG. 7 shows a sample buffer for use with the instrumentation record in FIG. 6, in accordance with one embodiment;

FIG. 8 shows an instrumentation record having thread identifications associated with the data in the record.

FIG. 9A shows a call stack associated with a first thread and a first sample point in the instrumentation record of FIG. 8;

FIG. 9B shows a call stack associated with a second thread and a first sample point in the instrumentation record of FIG. 8;

FIG. 10A shows a call stack associated with a first thread and a second sample point in the instrumentation record of FIG. 8;

FIG. 10B shows a call stack associated with a second thread and a second sample point in the instrumentation record of FIG. 8;

FIG. 11 shows an instrumentation record having time stamps and thread identifications associated with the data in the record.

FIG. 12A shows a call stack associated with a first thread and a first sample point in the instrumentation record of FIG. 11;

FIG. 12B shows a call stack associated with a second thread and a first sample point in the instrumentation record of FIG. 11;

FIG. 13A shows a call stack associated with a first thread and a second sample point in the instrumentation record of FIG. 11;

FIG. 13B shows a call stack associated with a second thread and a second sample point in the instrumentation record of FIG. 1; and

FIG. 14 shows a computer system upon which embodiments of the invention may be implemented.

### DETAILED DESCRIPTION OF THE PREFERRED EMBODIMENT

In the following description, for the purposes of explanation, numerous specific details are set forth in order to provide a thorough understanding of the present invention. However, it will be apparent to one skilled in the art that the invention may be practiced without these specific details. In other instances, well-known structures and devices are shown in block diagram form in order to avoid obscuring the invention.

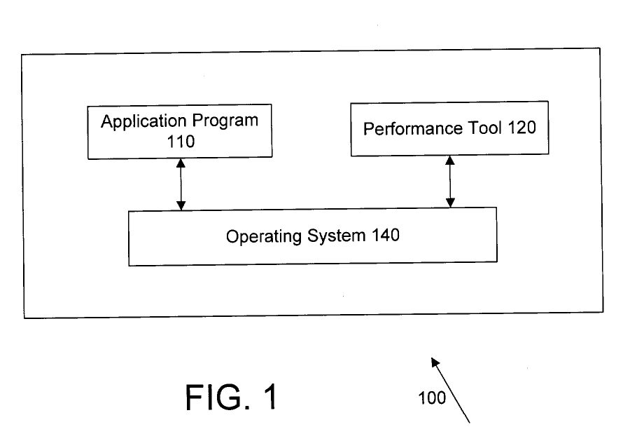

FIG. 1 shows a system 100 upon which embodiments of the invention may be implemented. System 100 includes an operating system 140 providing a platform for running various programs illustratively shown as an application 110 and a performance tool 120.

### The Program Application

In general, application 110 includes a plurality of programming functions 1105 (not shown). A function refers to a section of programming code callable by other code and encompasses subroutines in the Fortran language, procedures in the Pascal language, methods in the C++ language, and other similar constructs in the programming art. In general, a function includes a set of instructions beginning at an entry point and ending at an exit point. When a function is invoked, execution begins at the entry point. After the exit point, execution control is returned to the instruction following the calling code. The first entry point and the last exit point in a function having multiple entry points and/or multiple exit points define the function.

### Dynamic Instrumentation

Dynamic instrumentation is used in various software engineering domains such as performance analysis, program optimization, quality assurance, etc. Dynamic instrumentation tools generally add probe code to the original code of an application to form instrumented code and execute this instrumented code. Some examples of instrumentation operations include adding values to a register, moving the content of one register to another register, moving the address of some data to some registers, inserting a counter at a function entry point to count the number of function invocations, etc.

In one embodiment, application 110 is instrumented so that, at each entry and exit point of a function 1105 to be monitored, instructions are added to record when execution has entered or exited that function. While application 110 is executing, the instrumented program code generates instrumentation records of those entry and exit points. Depending on implementation, each function entry and exit point may also be time stamped. Further, the start address of a function 1105 is recorded, and therefore the name of the function is not needed.

### The Performance Tool & Profiling of Program Application

Generally, performance tool 120 helps programmers optimize the code of application 110, and may need information related to the call stack of application 110, which helps identify hot functions and provides the call chain, based on which program performance can be improved. Hot functions are those frequently invoked. The call chain indicates the sequence of function calls, e.g., the caller of a function, the caller of the caller, etc. In embodiments where instruction pointers are recorded, these pointers, providing the address of instructions, allow programmers to discover hot instructions, e.g., within hot functions.

In one embodiment, while application 110 is executing and function entry and exit points are recorded, performance tool 120 takes samples at time intervals. At each sample point, the function entry and exit records for that sample point have already been generated, performance tool 120 stops application 110, records the instruction pointer, and allows application 110 to resume execution. While application 110 is being executed again, performance tool 120 constructs the call stack for the sample point. Based on the function entry and exit records, each time a function entry is encountered, the entry point is pushed onto a pseudo-call stack; each time a function exit is encountered, an entry point is popped off the pseudo-call stack. When all function entry and exit records prior to the sample point have been thus processed, the resulting pseudo-call stack mirrors the state of the actual call stack at the time of the sample point. Once the desired instrumented function entry and exit records are processed, performance tool 120 discards this data. In one embodiment, before a sample point is sampled, a timer is set, and application 110 is stopped for sampling when the timer expires, e.g., counts down to zero. Depending on implementation, sampling intervals may be regular, e.g., the times between sample points are about the same, or irregular, e.g., the times vary from one sample point to another sample point.

The sampled instruction pointers help identify instructions at each sample point. However, if this information is not desired, then embodiments of the invention do not record the instruction pointers and thus do not stop application 110 at each sample point. While application 110 is executing, the instrumented code keeps generating the instrumentation records. At a sample point, e.g., when the timer expires, performance tool 120 identifies the recorded data for that sample point, and, based on this data, constructs the call stack. Once the call stack is constructed, performance tool 120 also discards the data related to this call stack. To mark the end of the data for a sample point, performance tool 120 may append an “end of data” record, e.g., the value 0×FFFF, to the instrumentation records.

Because the data is discarded once it is processed, embodiments of the invention do not have to manage accumulative data like other approaches. This accumulative data can be enormous, especially for large, longer-running applications. Further, because application 110 is allowed to resume execution while the call stack is being constructed from function entry and exit records, the invention has much less effect on the run-time performance of the application than do approaches that stop the application and unwind the stack while the application sits idle.

### The Instrumentation Records

In one embodiment, instrumentation records of function entry and exit points are kept to track function invocations during execution of application 110. The records thus provide data to derive the order in which the functions are invoked and thus pushed onto, and off of, the call stack. Based on these records, a call stack may be reconstructed that is a mirror of the call stack at run time. Typically, the records provide information regarding the caller of a function, the caller of the caller, etc. However, at each sample point, once the desired information in the record is processed, e.g., the call stack is reconstructed, the record storing information related to that sample point is discarded. This is advantageous over other approaches in which the information records are accumulated and thus result in voluminous amount of data to be kept and later processed. In one embodiment, instrumentation records store instruction pointers from which the function at the top of the call stack may be ascertained. Instruction pointers provide the address of the instruction within an application that is being executed. Using the function address range information stored in the application, the function associated with a given instruction pointer can be obtained. Recognizing the instruction pointer repeatedly pointing to the same function indicates that that function is a “hot” function, e.g., frequently invoked.

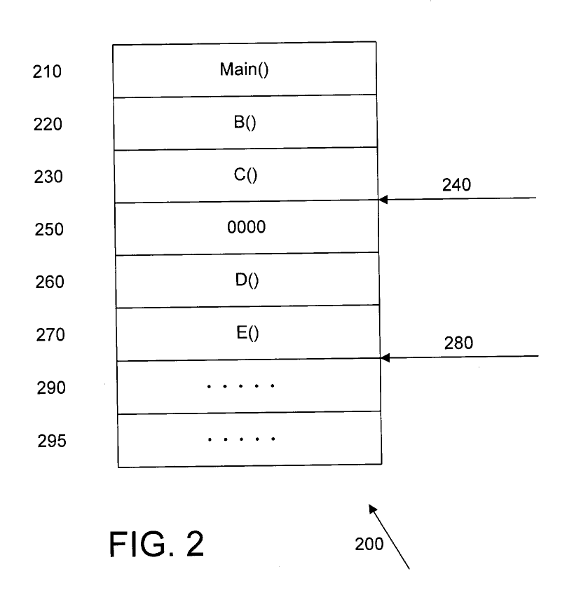

FIG. 2 shows an exemplary instrumentation record 200, in accordance with one embodiment. In this example, there are two sample points SP(1) and SP(2) (not shown). Lines 210, 220, and 230 indicate that execution progresses through the order of function main( ), function B( ), and function C( ). Pointer 240 indicates that application 110 is stopped for a sample point, e.g., first sample point SP(1). By processing the instrumentation records up to sample point SP(1), a pseudo-call stack is created including function main( ) calling function B( ) calling function C( ). Pointer 280 indicates that application 110 is stopped for another sample point, e.g., sample point SP(2). By processing the records from sample point SP(1) up to sample point SP(2), the pseudo-stack is updated to reflect the call stack at the time of sample point SP(2). Line 250, showing 0000, indicates that function C( ) has returned to function B( ), which is the caller of function C( ). The pseudo-stack is updated and now includes function main( )( ) calling function B( ). At line 260, the pseudo-stack becomes function main( ) calling function B( ) calling function D( ). At line 270, the pseudo-stack becomes function main( ) calling function B( ) calling function D( ) calling function E( ), which mirrors the actual call stack at sample point SP(2). Lines 290, 295, etc., indicate that record 200 may include additional data for additional sample points.

In one embodiment, instrumentation record 200 stores addresses, instead of the names, of function main( ), function A( ), function B( ), function C( ), etc., and when a return occurs the instrumentation record stores a zero value, such as the data on line 250.

As indicated above, at each sample point, the call stack at that point is reconstructed and the information related to that sample point and the corresponding call stack is discarded. As a result, information related to line 220 and line 230 are discarded after information related to the call stack for sample point SP(1) has been processed, e.g., the call stack has been reconstructed. Similarly, information related to lines 250-270 is discarded after information related to the call stack for sample point SP(2) has been processed.

In one embodiment, the instrumentation records are stored in buffers that may be referred to as call-trace buffers. A call-trace buffer, e.g., buffer Buf(1), is used to record data or traces until the buffer is full or until the buffer is fetched, e.g., is provided to a computing unit or entity to process the data. After buffer Buf(1) is filled or fetched, traces are written to a second buffer, e.g., buffer Buf(2). Once buffer Buf(2) is filled or fetched, traces are again written to buffer Buf(1), and so on, overwriting previous buffer data. Depending on implementation, one or multiple buffers Buf may be used. In one embodiment, sizes of buffers Buf are selected based on experimentation considering whether memory segments are too numerous because of too many small-sized buffers, whether the size of the buffer is too big that can cause inefficiencies in processing the data, etc.

### The Constructed Call Stacks

In general, a stack is a data structure in which items in the stack are removed from the stack in the reverse order as they are added to the stack. As a result, the item most recently added to the stack is the first removed. Commonly, adding an item and removing an item is referred to as pushing and popping, respectively. A call stack refers to a stack related to the functions that are invoked during execution of a program. The function at the top of the stack is the currently executing function. When a function is called by another function, it is pushed onto the top of the call stack. When a function exits, it is popped off the top of the call stack and its caller is again at the top of the stack. A call stack having functions M1, M2, M3, . . . , etc., may be referred to as /M1/M2/M3/ . . . in which the functions are pushed in the order of M1, M2, M3, etc., and popped in the order of M3, M2, M1, etc.

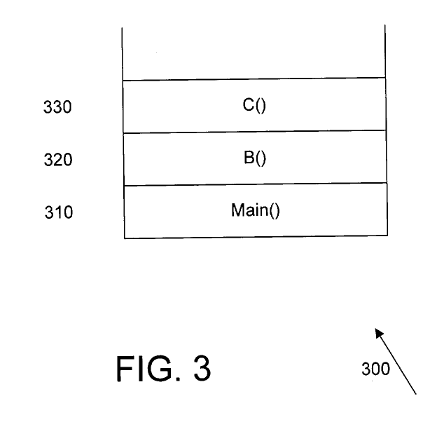

FIG. 3 shows a constructed call stack 300 that corresponds to first sample point SP(1) and that is constructed based on information in instrumentation record 200. Lines 310, 320, and 330 correspond to lines 210, 220, and 230, respectively. That is, at sample point SP(1), the stack has been pushed in the order of function main( ), function B( ), and function C( ).

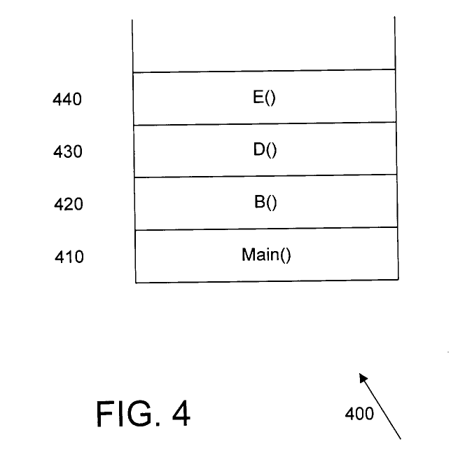

FIG. 4 shows a constructed call stack 400 that corresponds to second sample point SP(2) and that is constructed based on information in instrumentation record 200. Lines 410 and 420 were recorded as on the stack at sample point SP(1). Lines 430 and 440 correspond to lines 260 and 270, respectively, and reflect changes that occurred on the stack between sample point SP(1) and sample point SP(2). That is, the stack constructed at sample point SP(2) reflects that function C( ) was popped off the stack and that functions D( ) and E( ) were pushed onto the stack.

### Illustrative Steps to Acquire the Call Stack Information

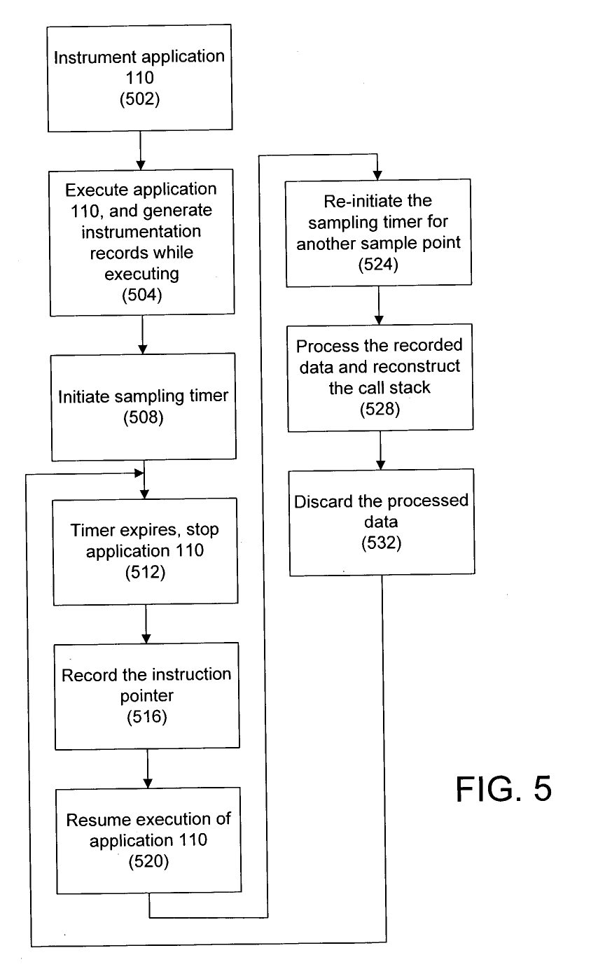

FIG. 5 is a flowchart 500 illustrating the steps in acquiring information in a call stack, in accordance with one embodiment. For illustration purposes, instrumentation record 200, and call stacks 300 and 400 are used as an example.

In step 502, application 110 is instrumented, e.g., being provided with instructions at each entry and exit point of every function to be monitored. Consequently, function main( ), function B( ), function C( ), function D( ), and function E( ) are instrumented.

In step 504, application 110 is executed, and, while application 110 is running, the instrumented program code of application 110 generates instrumentation record 200, which includes function entry and exit points for function main( ), function B( ), function C( ), function D( ), and function E( ).

In step 508, the sampling timer is initiated.

In step 512, the timer expires, and application 110 is stopped for a sample point, e.g., sample point SP(1).

In step 516, the instruction pointer is recorded.

In step 520, execution of application 110 is resumed.

In step 524, the timer is re-initiated for another sample point, e.g., sample point SP(2).

In step 528, instrumentation record 200 that, at this time, includes line 210 to line 230, is processed, and call stack 300 is thus constructed.

In step 532, the processed instrumentation records including lines 210-230 in instrumentation record 200 are discarded.

Flowchart 500 then continues at step 512 for another sample point, e.g., sample point SP(2). Accordingly, lines 250-270 are recorded, call stack 400 is constructed, and lines 250-270 are discarded, etc.

In the above example, instruction pointers recorded in step 516 are used to identify instructions at the sample points, e.g., sample points SP(1) and SP(2). However, if this information is not desired, then application 110 is not stopped in step 512, and step 516 and 520 may be skipped. That is, the instruction pointer is not recorded in step 516, and, because execution of application 110 is not stopped in step 512, it is not resumed in step 520.

### The Kernel Samples the Instruction Pointer

In one embodiment, instead of performance tool 120, the kernel or operating system 140, via the kernel's interface, samples application 110. Further, the instrumentation records, besides function entry and exit points, also include time stamps at each entry and exit points. After application 110 is instrumented, it is executed, and while executing, the instrumented code of application 110 continuously generates the instrumentation records including the time stamps. At each desire time, e.g., when a timer expires, that corresponds to a sample point, the kernel time stamps the sample point, stops execution of application 110, records the instruction pointer, which helps identify instructions at each sample point, and resumes execution of application 110. Those skilled in the computer art will recognize that the kernel stopping execution of application 110 takes lesser time than performance 120 does. Further, as in the previous embodiment, if information related to the instruction pointer is not desired, then the kernel does not record it, and thus does not need to stop execution of application 110. Upon acquiring the time stamps and instruction pointers for a number of sample points, the kernel provides the acquired data to performance tool 120. For illustration purposes, the number of sample points is eight. By the time performance tool 120 receives the data from the kernel, the instrumentation records for the corresponding eight sample points have been generated. Performance tool 120, based on the time stamps for the sample points, the time stamps for each function entry and exit point, the record for function entry and exit points, reconstructs the eight call stacks corresponding to the eight sample points.

For illustration purposes, each function entry and exit point corresponds to a time t, and each sample point corresponds to a time T, as time stamped by the kernel. Performance tool 120 uses times t and times T to construct the call stacks. For further illustration purposes, time T(1), T(2), . . . T(N) corresponds to sample points SP(1), SP(2), . . . SP(N), respectively. Data corresponding to time t that is in between time T(I-1) and time T(I), e.g., greater than time T(I-1) and less than time T(I), belongs to sample point SP(I), wherein I and N are integer numbers and I is less than N. For example, data corresponding to time t that is less than time T(1) belongs to sample point SP(1). Data corresponding to time t that is greater than time T(1) and less than time T(2) belongs to sample point SP(2). Data corresponding to time t that is greater than time T(2) and less than time T(3) belongs to time T(3), etc. For each data entry in the instrumentation record performance tool 120 locates the corresponding time t and compares it against a time T corresponding to a sample point until all entries corresponding to that sample point have been assigned to a call stack. Performance tool 120 continues through the instrumentation record until all data for all sample points have been assigned. In one embodiment, times T and their corresponding sample points are stored in a sample buffer, and if instruction pointers are recorded, then they are also stored in this sample buffer.

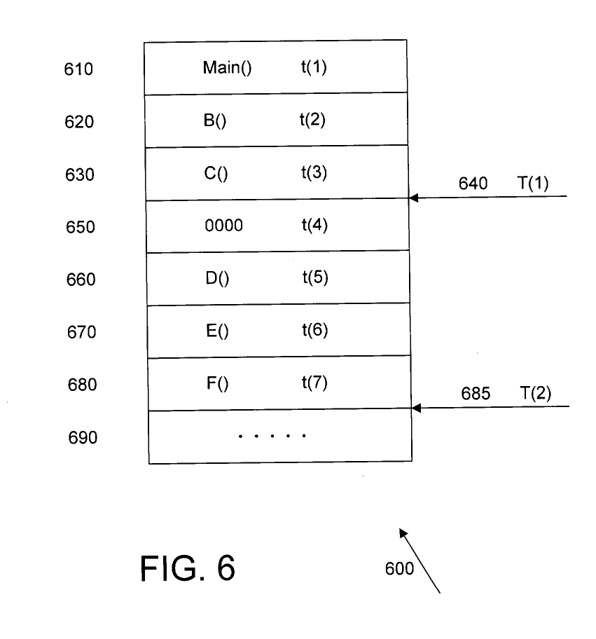

FIG. 6 shows an instrumentation record 600 having time stamps, in accordance with one embodiment. For illustration purposes, record 600 shows the data for sample point SP(1) and sample point SP(2). Sample point SP(1) includes function main( ), function B( ), and function C( ), while sample point SP(2) includes function main( ), function B( ), function D( ), function E( ), and function F( ). Lines 610, 620, 630, 660, 670, and 680 show that functions main( ), B( ), C( ), D( ), E( ), and F( )are invoked at times t(1), t(2), t(3), t(5), t(6), and t(7), respectively. Line 650 indicates that, at time t4, function C( ) returns to function B( ), and is thus popped out of the call stack. Pointer 640 shows the end of data for sample point SP(1) and that sample point SP(1) corresponds to, or is sampled at, time T(1). Similarly, pointer 685 shows the end of data for sample point SP(2) and that sample point SP(2) corresponds to, or is sampled at, time T(2).

The data corresponding to time t in record 600 that is less than time T(1) belongs to sample point SP(1) while the data corresponding to time t that is between time T(1) and time T(2) belongs to sample point SP(2). Based on the above information, the call stacks for sample points S(1) and S(2) can be constructed as /main/B/C and /main/B/D/E/F, respectively.

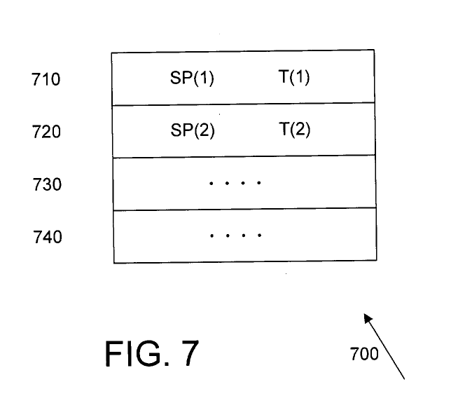

FIG. 7 shows an exemplary sample buffer 700 corresponding to sample points SP(1) and SP(2) in FIG. 6. Lines 710 and 720 show that sample points SP(1) and SP(2) correspond to time T(1) and time T(2), respectively. Lines 730, 740, etc., indicate that additional data for additional sample points may be included in buffer 700.

In general, the kernel runs on a process and performance tool 120 runs on a different process, and having the kernel sampling application 110 multiple points before providing the data to performance tool 120 reduces the number of context switches between the kernel and performance tool 120, which reduces perturbation to application 110's execution. A context switch occurs when a process running on a processor yields this processor for use by other processes. Having the kernel handle the groups of sample points also reduces the times that performance tool 120 spends on the processor. In one embodiment, the kernel provides a system call perfmon( ) that signals performance tool 120 each time a buffer of samples is ready.

### Multi-Threaded Applications

Techniques of the invention are also applicable in case application 110 runs on a process having multiple threads that simultaneously execute multiple functions. In general, a thread has its own call stack and a thread identification, e.g., TID. Multiple threads may share resources of the same process. When a thread is created, a function, e.g., function Tstart( ), is also created to start that thread. Function Tstart( ) to a thread is analogous to function main( ) to a process.

In one embodiment, the instrumented records and the time buffers also include the thread identifications TID to identify the threads, and the call stack for each thread is constructed as above considering the thread identifications. During processing the instrumentation records, and, for each sample point, a function is assigned to a call stack corresponding to a thread based on the thread identification carried by that function. For example, if a function carries a thread identification TID(1), then the function is assigned to the call stack for a thread, e.g., Thr(1). If the function carries a thread identification TID(2), then the function is assigned to the call stack for a thread, e.g., Thr(2), etc.

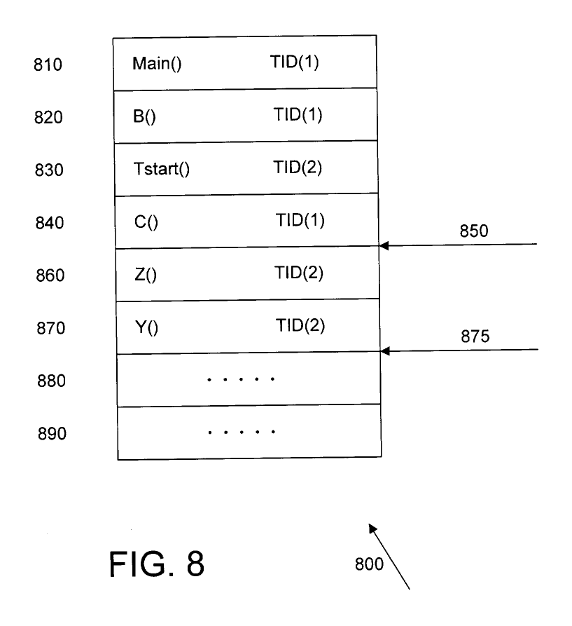

FIG. 8 shows an instrumentation record 800 including thread identifications TID. Lines 810, 820, and 840 indicate that function main( ), function B( ), and function C( ) carry thread identification TID(1), and therefore run on a thread, e.g., thread Thr(1). Lines 830, 860, and 870 indicate that function Tstart( ), function Z( ), and function Y( ) carry thread identification TID(2), and therefore run on a thread, e.g., thread Thr(2). Pointers 850 and 875 indicate the end of data for sample points SP(1) and SP(2), respectively.

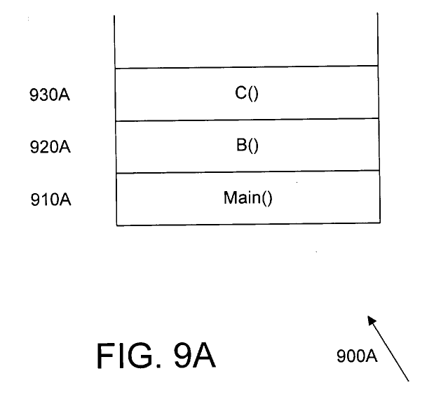

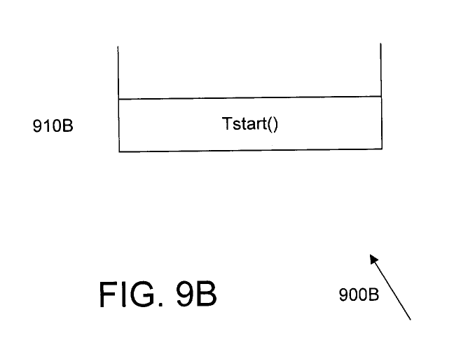

FIGS. 9A and 9B show constructed call stacks 900A and 900B corresponding to respective thread Thr(1) and thread Thr(2) of sample point SP(1) in FIG. 8. Stack 900A includes data corresponding to lines 810, 820 and 840, all of which carry thread identification TID(1) indicating that function main( ), function B( ), and function C( ) run on thread Thr(1). Lines 910A, 920A, and 930A correspond to lines 810, 820, and 840, respectively.

Stack 900B includes data corresponding to line 830, which carries thread identification TID(2) indicating that function Tstart runs on thread Thr(2). Line 910B corresponds to line 830.

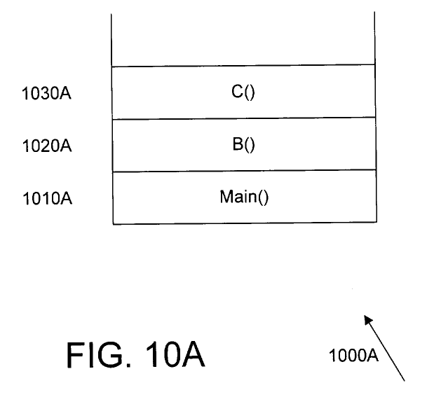

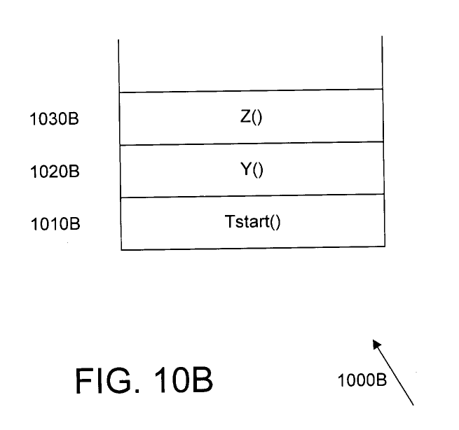

FIGS. 10A and 10B show constructed call stacks 1000A and 1000B corresponding to respective thread Thr(1) and thread Thr(2) of sample point SP(2) in FIG. 8. Because there is no change in the call stack for thread Thr(1) between sample point SP(1) and sample point SP(2), the call stack for thread Thr(1) for sample point SP(2), e.g., call stack 1000A, is the same as call stack 900A. Lines 1010A, 1020A, and 1030A correspond to lines 810, 820, and 840, respectively.

In stack 1000B, because functions Z( ) and Y( ) are pushed to the stack between sample point SP(1) and sample point SP(2), stack 1000B includes the data in stack 900B plus additional pushed data, e.g., functions Y( ) and function Z( ). Thus, lines 1100B, 1020B, and 1030B correspond to lines 830, 860, and 870, respectively.

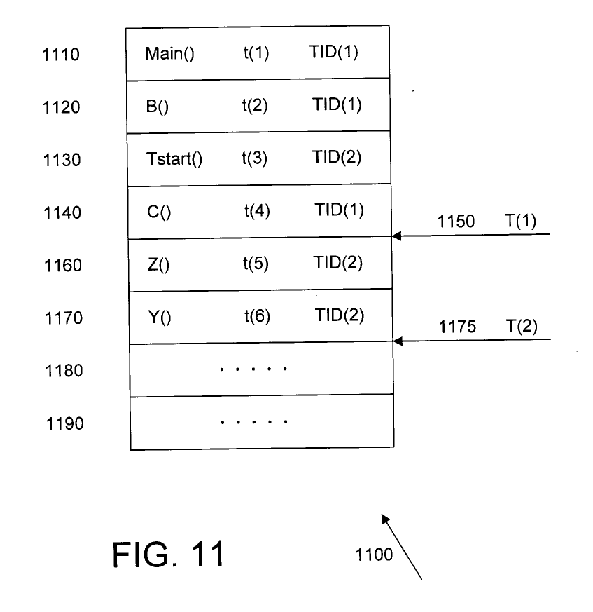

FIG. 11 shows an instrumentation record 1100 including time stamps and thread identifications TID. Lines 1110, 1120, and 1140 indicate that function main( ), function B( ), and function C( ) carry thread identification TID(1), and therefore run on a thread, e.g., thread Thr(1). Lines 1130, 1160, and 1170 indicate that function Tstart( ), function ZO( ), and function Y( ) carry thread identification TID(2), and therefore run on a thread, e.g., thread Thr(2). Pointers 1150 and 1175 indicate the end of data for sample points SP(1) and SP(2), respectively, and that sample points SP(1) and SP(2) correspond to times T(1) and T(2), respectively. Sample point SP(1) includes data on lines 1110, 1120, 1130, and 1140 corresponding to times t(1), t(2), t(3), and t(4), respectively. Sample point SP(2) includes data on lines 1160 and 1170 corresponding to times t(5) and t(6), respectively.

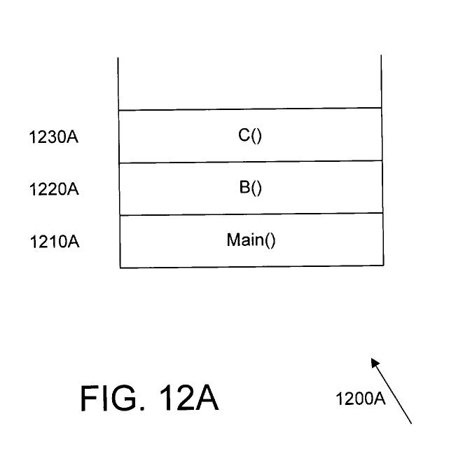

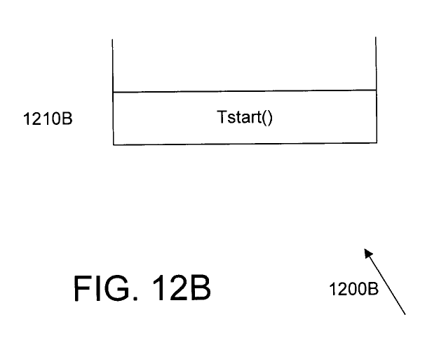

FIGS. 12A and 12B show constructed call stacks 1200A and 1200B corresponding to respective thread Thr(1) and thread Thr(2) of sample point SP(1) in FIG. 11. Data on lines 1110-1140 correspond to times t(1)-t(4) that are less than time T(1) and thus belong to sample point SP(1). Stack 1200A includes data on lines 1110, 1120 and 1140, all of which carry thread identification TID(1) indicating that function main( ), function B( ), and function C( ) run on thread Thr(1). Lines 1210A, 1220A, and 1230A correspond to lines 1110, 1120, and 1140, respectively.

Stack 1200B includes data on line 1130, which carries thread identification TID(2) indicating that function Tstart runs on thread Thr(2). Line 1210B corresponds to line 1130.

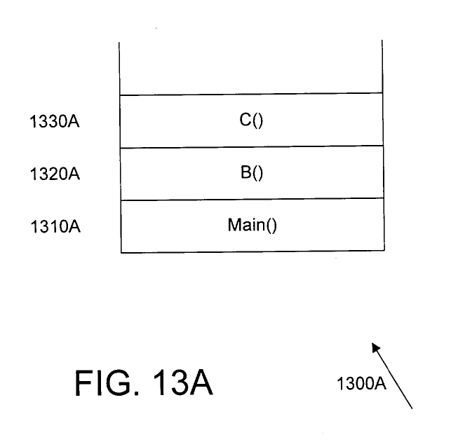

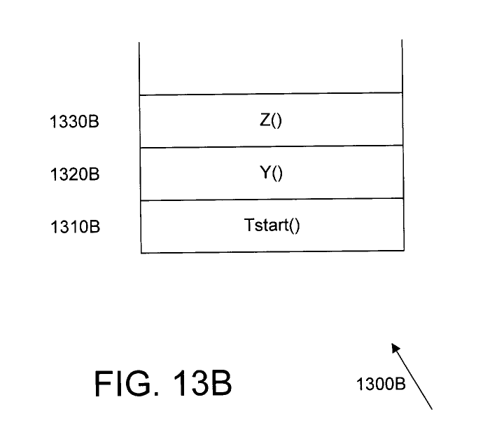

FIGS. 13A and 13B show constructed call stacks 1300A and 1300B corresponding to respective thread Thr(1) and thread Thr(2) of sample point SP(2) in FIG. 11. Data on lines 1160 and 1170 correspond to times t(5) and t(6) that are greater than time T(1) and less than time T(2), and thus belong to sample point SP(2). Because there is no change in the call stack for thread Thr(1) between sample point SP(1) and sample point SP(2), the call stack for thread Thr(1) for sample point SP(2), e.g., call stack 1300A, is the same as call stack 1200A. Lines 1310A, 1320A, and 1330A correspond to lines 1110, 1120, and 1140, respectively.

In stack 1300B, because functions Z( ) and Y( ) are pushed to the stack between sample point SP(1) and sample point SP(2), stack 1300B includes the data in stack 1200B plus additional pushed data, e.g., functions Y( ) and function Z( ). Thus, lines 1310B, 1320B, and 1330B correspond to lines 1130, 1160, and 1170, respectively.

### Computer System Overview

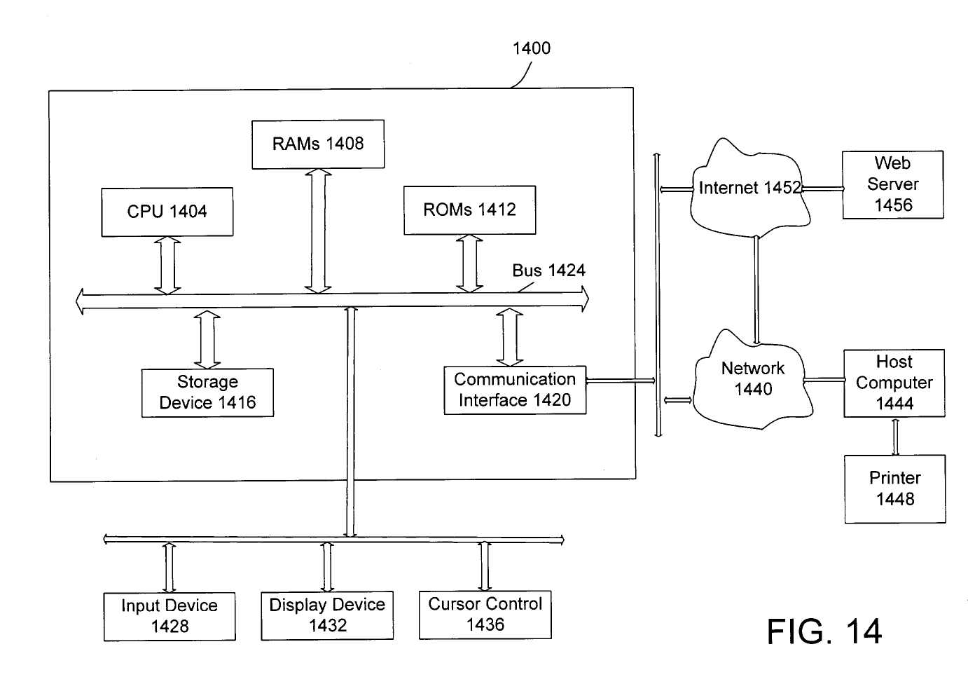

FIG. 14 is a block diagram showing a computer system 1400 upon which an embodiment of the invention may be implemented. For example, computer system 1400 may be implemented to operate as a system 100, to perform functions in accordance with the techniques described above, etc. In one embodiment, computer system 1400 includes a central processing unit (CPU) 1404, random access memories (RAMs) 1408, read-only memories (ROMs) 1412, a storage device 1416, and a communication interface 1420, all of which are connected to a bus 1424.

CPU 1404 controls logic, processes information, and coordinates activities within computer system 1400. In one embodiment, CPU 1404 executes instructions stored in RAMs 1408 and ROMs 1412, by, for example, coordinating the movement of data from input device 1428 to display device 1432. CPU 1404 may include one or a plurality of processors.

RAMs 1408, usually being referred to as main memory, temporarily store information and instructions to be executed by CPU 1404. Information in RAMs 1408 may be obtained from input device 1428 or generated by CPU 1404 as part of the algorithmic processes required by the instructions that are executed by CPU 1404.

ROMs 1412 store information and instructions that, once written in a ROM chip, are read-only and are not modified or removed. In one embodiment, ROMs 1412 store commands for configurations and initial operations of computer system 1400.

Storage device 1416, such as floppy disks, disk drives, or tape drives, durably stores information for use by computer system 1400.

Communication interface 1420 enables computer system 1400 to interface with other computers or devices. Communication interface 1420 may be, for example, a modem, an integrated services digital network (ISDN) card, a local area network (LAN) port, etc. Those skilled in the art will recognize that modems or ISDN cards provide data communications via telephone lines while a LAN port provides data communications via a LAN. Communication interface 1420 may also allow wireless communications.

Bus 1424 can be any communication mechanism for communicating information for use by computer system 1400. In the example of FIG. 14, bus 1424 is a media for transferring data between CPU 1404, RAMs 1408, ROMs 1412, storage device 1416, communication interface 1420, etc.

Computer system 1400 is typically coupled to an input device 1428, a display device 1432, and a cursor control 1436. Input device 1428, such as a keyboard including alphanumeric and other keys, communicates information and commands to CPU 1404. Display device 1432, such as a cathode ray tube (CRT), displays information to users of computer system 1400. Cursor control 1436, such as a mouse, a trackball, or cursor direction keys, communicates direction information and commands to CPU 1404 and controls cursor movement on display device 1432.

Computer system 1400 may communicate with other computers or devices through one or more networks. For example, computer system 1400, using communication interface 1420, communicates through a network 1440 to another computer 1444 connected to a printer 1448, or through the world wide web 1452 to a server 1456. The world wide web 1452 is commonly referred to as the “Internet.” Alternatively, computer system 1400 may access the Internet 1452 via network 1440.

Computer system 1400 may be used to implement the techniques described above. In various embodiments, CPU 1404 performs the steps of the techniques by executing instructions brought to RAMs 1408. In alternative embodiments, hard-wired circuitry may be used in place of or in combination with software instructions to implement the described techniques. Consequently, embodiments of the invention are not limited to any one or a combination of software, firmware, hardware, or circuitry.

Instructions executed by CPU 1404 may be stored in and/or carried through one or more computer-readable media, which refer to any medium from which a computer reads information. Computer-readable media may be, for example, a floppy disk, a hard disk, a zip-drive cartridge, a magnetic tape, or any other magnetic medium, a CD-ROM, a CD-RAM, a DVD-ROM, a DVD-RAM, or any other optical medium, paper-tape, punch-cards, or any other physical medium having patterns of holes, a RAM, a ROM, an EPROM, or any other memory chip or cartridge. Computer-readable media may also be coaxial cables, copper wire, fiber optics, acoustic or electromagnetic waves, capacitive or inductive coupling, etc. As an example, the instructions to be executed by CPU 1404 are in the form of one or more software programs and are initially stored in a CD-ROM being interfaced with computer system 1400 via bus 1424. Computer system 1400 loads these instructions in RAMs 1408, executes some instructions, and sends some instructions via communication interface 1420, a modem, and a telephone line to a network, e.g. network 1440, the Internet 1452, etc. A remote computer, receiving data through a network cable, executes the received instructions and sends the data to computer system 1400 to be stored in storage device 1416.

In the foregoing specification, the invention has been described with reference to specific embodiments thereof. However, it will be evident that various modifications and changes may be made thereto without departing from the broader spirit and scope of the invention. Accordingly, the specification and drawings are to be regarded as illustrative rather than as restrictive.

What is claimed is:

1. A method for acquiring information about call stacks of a program, comprising the steps of:
while the program is executing
recording the order of function entries and exits of the program;
at a sample point, identifying the recorded order of function entries and exits for the sample point;
based on the recorded order of function entries and exits, constructing the call stack at the sample point; and
discarding records of order of function entries and exits at the sample point.

2. The method of claim 1 further comprising the steps of:
stopping execution of the program at the sample point;
recording a pointer pointing to an instruction; and
resuming execution of the program.

3. The method of claim 1 further comprising the step of setting a timer before the step of identifying the recorded order of function entries and exits, and the step of identifying the recorded order of function entries and exits occurs upon expiration of the timer.

4. The method of claim 1 wherein the step of identifying the recorded order of function entries and exits occurs at a time interval.

5. The method of claim 1 further comprising the step of using addresses of functions to record the function entries.

6. The method of claim 1 further comprising the step of instrumenting functions to record the function entries and exits.

7. The method of claim 1 wherein the recorded order of function entries and exits is used in identifying one or a combination of hot functions, callers of hot functions, and hot call chains of the program.

8. The method of claim 1 wherein a programming tool performs one or a combination of the steps of identifying the recorded order of function entries and exits, constructing the call stack, and discarding the recorded order of function entries and exits.

9. The method of claim 1 wherein the program runs on multiple threads each having a thread identification.

10. The method of claim 9 wherein a thread of the multiple threads is associated with a call stack of the call stacks.

11. The method of claim 9 further comprising the steps of recording thread identifications each corresponding to a function run in the program, and, based on a thread identification corresponding to a function, assigning that function to a call stack of the call stacks.

12. The method of claim 1 wherein the step of constructing the call stack at the sample point comprising the step of pushing a function onto a pseudo stack upon encountering an entry for that function or popping the function off of the pseudo stack upon encountering an exit for that function.

13. A method for acquiring information about call stacks associated with a set of sample points of a program, comprising the steps of:
while the program is executing
recording the order of function entries and exits of the program;
recording a first set of time stamps each corresponding to a function entry or exit;
recording a second set of time stamps each corresponding to a sample point in the set of sample points;
based on the recorded order of function entries and exits, the relationship between the first set of time stamps and the second set of time stamps, reconstructing the call stacks each corresponding to a sample point in the set of sample points.

14. The method of claim 13 further comprising the step of discarding records related to the order of function entries and exits before using the method for another set of sample points.

15. The method of claim 13 wherein:
the set of sample points are identified as sample points SP(1) to SP(N) corresponding to time T(1) to time T(N) in the second set of time stamps; and
determining whether a function belongs to a sample point SP(I) uses the time stamp associated with a function entry or exit, a time T(I-1), and a time T(I);
I and N are integer numbers; and
I is less than N.

16. The method of claim 13 wherein:
the set of sample points are identified as sample points SP(1) to SP(N) corresponding to times T(1) to time T(N) in the second set of time stamps,
a function entry or exit associated with a time stamp in the first set of time stamps that is in between time T(I-1) and time T(I) belongs to a sample point SP(I),
and N are integer numbers, and
is less than N.

17. The method of claim 13, upon recording a time stamp in the second set of time stamps, further comprising the steps of stopping the program, recording a pointer pointing to an instruction, and resuming execution of the program.

18. The method of claim 13 further comprising the step of initiating a timer, and recording a time stamp in the step of recording the second set of time stamps occurs when the timer expires.

19. The method of claim 13 wherein recording a time stamp in the step of recording the second set of time stamps occurs at a time interval.

20. The method of claim 13 further comprising the step of using address of functions to record the function entries.

21. The method of claim 13 further comprising the step of instrumenting functions to record the function entries and exits.

22. The method of claim 13 wherein the order of function entries and exits is used in identifying one or a combination of hot functions, callers of hot functions, and hot call chains of the program.

23. The method of claim 13 wherein:
a kernel of an operating system running the program performs the step of recording the second set of time stamps; and
a software tool performs the step of constructing the call stacks.

24. The method of claim 23, upon recording a time stamp in the second set of time stamps, the kernel further performing the steps of stopping execution of the program, recording a pointer pointing to an instruction, and resuming execution of the program.

25. The method of claim 13 wherein the program runs on multiple threads each having a thread identification.

26. The method of claim 25 wherein each of the multiple threads is associated with a call stack of the call stacks.

27. The method of claim 25 further comprising the steps of recording thread identifications each corresponding to a function run in the program and, based on a thread identification corresponding to a function, assigning that function to a call stack of the call stacks.

28. The method of claim 13 wherein the step of constructing the call stacks comprising the step of pushing a function onto a pseudo stack upon encountering an entry for that function or popping the function off of the pseudo stack upon encountering an exit for that function.

29. A computer-readable medium embodying instructions for a computer to perform a method for acquiring information about call stacks of a program, the method comprising the steps of:
while the program is executing
recording the order of function entries and exits of the program;
at a sample point, identifying the recorded order of function entries and exits for the sample point;
based on the recorded order of function entries and exits, constructing the call stack at the sample point; and
discarding records of order of function entries and exits at the sample point.

30. The computer-readable medium of claim 29 wherein the method further comprising the steps of:
stopping execution of the program at the sample point;
recording a pointer pointing to an instruction; and
resuming execution of the program.

31. The computer-readable medium of claim 29 wherein the method further comprising the step of setting a timer before the step of identifying the recorded order of function entries and exits, and the step of identifying the recorded order of function entries and exits occurs upon expiration of the timer.

32. The computer-readable medium of claim 29 wherein the step of identifying the recorded order of function entries and exits occurs at a time interval.

33. The computer-readable medium of claim 29 wherein the method further comprising the step of using addresses of functions to record the function entries.

34. The computer-readable medium of claim 29 wherein the method further comprising the step of instrumenting functions to record the function entries and exits.

35. The computer-readable medium of claim 29 wherein the recorded order of function entries and exits is used in identifying one or a combination of hot functions, callers of hot functions, and hot call chains of the program.

36. The computer-readable medium of claim 29 wherein a programming tool performs one or a combination of the steps of identifying the recorded order of function entries and exits, constructing the call stack, and discarding the recorded order of function entries and exits.

37. The computer-readable medium of claim 29 wherein the program runs on multiple threads each having a thread identification.

38. The computer-readable medium of claim 37 wherein a thread of the multiple threads is associated with a call stack of the call stacks.

39. The computer-readable medium of claim 37 wherein the method further comprising the steps of recording thread identifications each corresponding to a function run in the program, and, based on a thread identification corresponding to a function, assigning that function to a call stack of the call stacks.

40. The computer-readable medium of claim 29 wherein the step of constructing the call stack at the sample point comprising the step of pushing a function onto a pseudo stack upon encountering an entry for that function or popping the function off of the pseudo stack upon encountering an exit for that function.

41. A computer-readable medium embodying instructions for a computer to perform a method for acquiring information about call stacks associated with a set of sample points of a program, the method comprising the steps of:
while the program is executing
recording the order of function entries and exits of the program;
recording a first set of time stamps each corresponding to a function entry or exit;
recording a second set of time stamps each corresponding to a sample point in the set of sample points;
based on the recorded order of function entries and exits, the relationship between the first set of time stamps and the second set of time stamps, reconstructing the call stacks each corresponding to a sample point in the set of sample points.

42. The computer-readable medium of claim 41 wherein the method further comprising the step of discarding records related to the order of function entries and exits before using the method for another set of sample points.

43. The computer-readable medium of claim 41 wherein:
the set of sample points are identified as sample points SP(1) to SP(N) corresponding to time T(1) to time T(N) in the second set of time stamps; and
determining whether a function belongs to a sample point SP(I) uses the time stamp associated with a function entry or exit, a time T(I-1), and a time T(I);
I and N are integer numbers; and
I is less than N.

44. The computer-readable medium of claim 41 wherein:
the set of sample points are identified as sample points SP(1) to SP(N) corresponding to times T(1) to time T(N) in the second set of time stamps,
a function entry or exit associated with a time stamp in the first set of time stamps that is in between time T(I-1) and time T(I) belongs to a sample point SP(I),
and N are integer numbers, and
is less than N.

45. The computer-readable medium of claim 41 wherein the method, upon recording a time stamp in the second set of time stamps, further comprising the steps of stopping the program, recording a pointer pointing to an instruction, and resuming execution of the program.

46. The computer-readable medium of claim 41 wherein the method further comprising the step of initiating a timer, and recording a time stamp in the step of recording the second set of time stamps occurs when the timer expires.

47. The computer-readable medium of claim 41 wherein recording a time stamp in the step of recording the second set of time stamps occurs at a time interval.

48. The computer-readable medium of claim 41 wherein the method further comprising the step of using address of functions to record the function entries.

49. The computer-readable medium of claim 41 wherein the method further comprising the step of instrumenting functions to record the function entries and exits.

50. The computer-readable medium of claim 41 wherein the order of function entries and exits is used in identifying one or a combination of hot functions, callers of hot functions, and hot call chains of the program.

51. The computer-readable medium of claim 41 wherein:
a kernel of an operating system running the program performs the step of recording the second set of time stamps; and
a software tool performs the step of constructing the call stacks.

52. The computer-readable medium of claim 51 wherein the kernel, upon recording a time stamp in the second set of time stamps, further performing the steps of stopping execution of the program, recording a pointer pointing to an instruction, and resuming execution of the program.

53. The computer-readable medium of claim 41 wherein the program runs on multiple threads each having a thread identification.

54. The computer-readable medium of claim 53 wherein each of the multiple threads is associated with a call stack of the call stacks.

55. The computer-readable medium of claim 53 wherein the method further comprising the steps of recording thread identifications each corresponding to a function run in the program and, based on a thread identification corresponding to a function, assigning that function to a call stack of the call stacks.

56. The computer-readable medium of claim 41 wherein the step of constructing the call stacks comprising the step of pushing a function onto a pseudo stack upon encountering an entry for that function or popping the function off of the pseudo stack upon encountering an exit for that function.
